(19) United States
(12) Patent Application Publication
(10) Pub. No.: US 2012/0123840 A1
(43) Pub. Date: May 17, 2012

(54) Low cost and effective means for generating sales and raising finance

(76) Inventor: Nahlyee Van P.G. Brunt, Mountain View, CA (US)

(21) Appl. No.: 12/947,550

(22) Filed: Nov. 16, 2010

(51) Int. Cl. G06Q 30/00

(52) U.S. Cl. 705/14.23; 705/14.35; 705/14.1

(57) ABSTRACT

A method for enabling low cost and effective sale transactions between buyers and sellers is provided, wherein the method is enabled by a system comprising one or more client interfaces and at least one server. Sellers list one or more Price Credits (PCs), and one or more goods on a server for buyers to buy. The discount on a good or a service is equal to the face value of the corresponding PC being offered to buy the good. Buyers can buy PCs using Price Exception Guarantees (PEGs). Buyers may further buy merchant tokens using PCs. Buyers may also resell PCs and merchant tokens before expiration of validity. Sellers may use merchant tokens to raise low cost and effective financing.

This application claims the benefit of U.S. Provisional Application No. 61/254,204 filed on Nov. 20, 2009, which is herein incorporated by reference.

### TECHNICAL FIELD

The embodiments herein relate to social commerce and, more particularly, to low cost and effective means for generating sales, and financing for sellers.

### BACKGROUND

Advertising, and more particularly promotions, is a key driver for sales for any seller. Distributing coupons is one of the most important ways in which local sellers promote their services by offering discounts depending on the season and market conditions. Various attempts have been made to make the process of promotions and coupon distribution easily accessible to users and, thereby, benefit both sellers and buyers. Even with the mechanisms to make the process of promotions easy, local sellers spend billion of dollars on advertising and promotions, making the cost of doing business significantly higher. This ultimately results in higher prices to the end consumer. Further, sellers must pay credit card processing fees to accept credit card payments (a common method of payment by consumers) further increasing the cost of doing business. While large businesses may be able to absorb additional costs relating to promotions, credit card processing, and the like easily due to economies of scale, local sellers, which are usually small businesses, are placed in a disadvantageous position due to the lack of economies of scale.

Many small sellers use social networking sites such as Facebook and Twitter to promote their businesses by advertising on the social networking sites. However, the companies would not be able to know how effective their advertising has been on the social networking sites. Further, it is very difficult for a seller to build trust through social networking platforms as buyers on such platforms encounter hundreds of seller trying to promote their goods and services. For example, prospective buyers may search for local healthcare and insurance providers. However, in order for users to consider the services immediately, the user must be assured that the advertised service provider is trust worthy. Existing mechanisms do not ensure trust worthiness of sellers, and, as a result, trust worthy sellers may lose opportunity to show case their goods or services.

Furthermore, while there may be facilities for people search for local service providers, they may not be able to purchase a good immediately, even though they like a good, as such offerings are not integrated online for most local sellers. This may further result in local sellers losing business opportunities.

Another problem facing local sellers is that of financing. Raising venture capital and securing bank loans is often a difficult and rarely successful option for local sellers, which are mostly small businesses. Small local sellers do not currently have a low cost and effective alternative to debt and equity financing to grow their business.

### BRIEF DESCRIPTION OF THE FIGURES

The embodiments herein will be better understood from the following detailed description with reference to the drawings, in which:

FIG. 1 illustrates a block diagram of a network to enable sale transactions between buyers and sellers, according to an embodiment herein;

FIG. 2 is a flowchart depicting a method for enabling a buyer to search for and buy goods or services, according to an embodiment herein;

FIG. 3 is a flowchart depicting a method for enabling a seller to sell goods or services, according to an embodiment herein;

FIG. 4 is a flowchart depicting a method for enabling buyers to exchange price credits, according to an embodiment herein;

FIG. 5 illustrates a block diagram of a network wherein a web-interface enables sale transactions between buyers and sellers, according to an embodiment herein;

FIG. 6 illustrates a schematic diagram of a web page, in accordance with the embodiments herein;

FIG. 7 illustrates a schematic diagram of a page used by buyers to buy goods or avail of a service, in accordance with the embodiments herein;

FIG. 8 illustrates a schematic diagram of a page used by buyers to “peg” and buy goods or services, in accordance with the embodiments herein;

FIG. 9 illustrates a schematic diagram of a page used by sellers to lists goods, services and PC, in accordance with the embodiments herein;

FIG. 10 illustrates a block diagram of a network wherein a T.V. enables sale transactions between buyers and sellers, according to an embodiment herein; and

FIG. 11 illustrates a block diagram of a set top box, according to an embodiment herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein provide low cost and effective means for generating sales, and financing using virtual currency Price Exception Guarantees (PEGs), price credits (PCs), and merchant tokens.

A PEG is a form of virtual currency that can be easily converted to another virtual currency issued/offered by a seller. Virtual Currency PEGs create a method of payment for consumers enabling buyers to save money on every purchase made.

A PC is a digital advertisement made by a seller to a prospective buyer offering an exclusive discount on certain goods or services in a limited quantity, in a certain geographic area for a limited time period.

A merchant token is a virtual currency offered by a seller as an alternative mode of payment for goods and services.

The words “goods”, “items”, “good”, and “item” may mean one or a combination of different or same kind of goods and services, both virtual and physical.

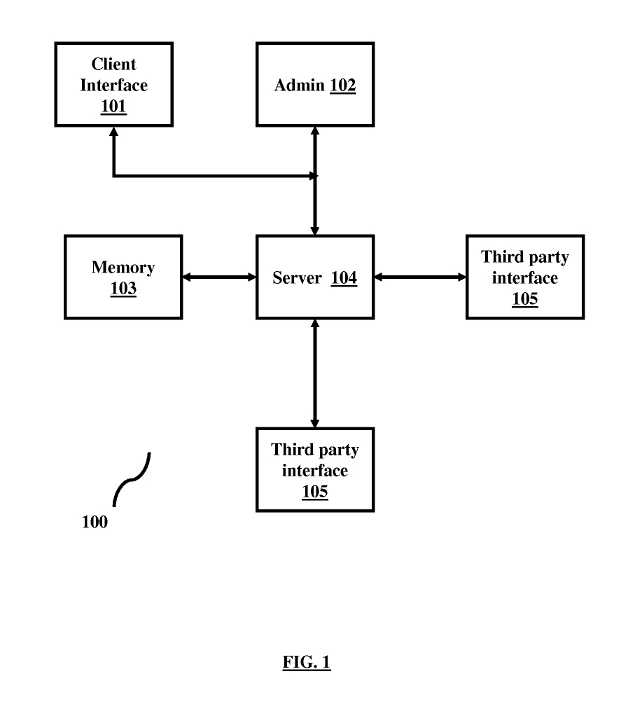

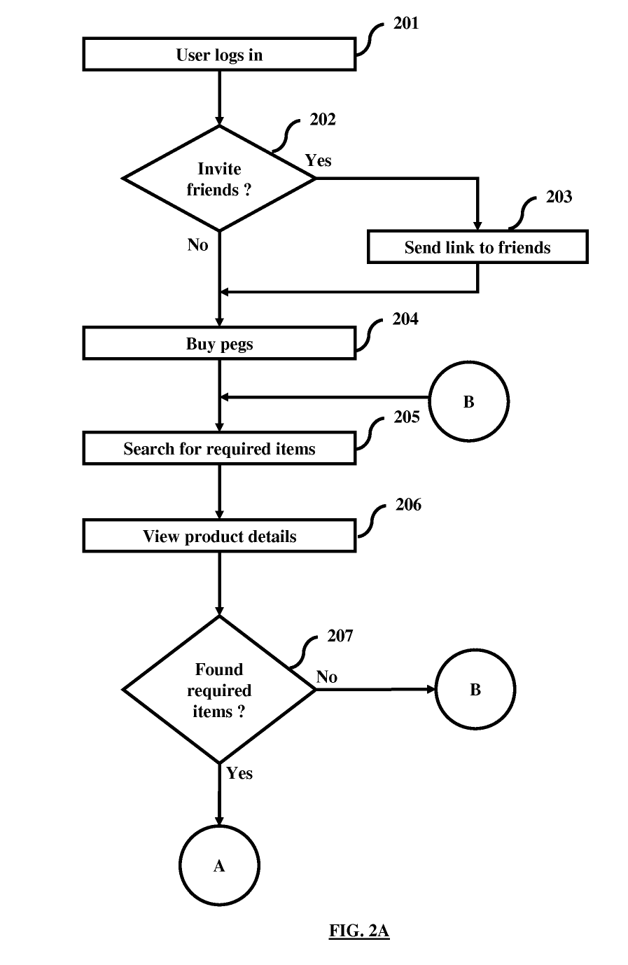

Referring now to the drawings, and more particularly to FIGS. 1 through 11, where similar reference characters denote corresponding features consistently throughout the figures, there are shown embodiments.

### Low Cost and Effective Generation of Sales

### System Description

FIG. 1 illustrates a block diagram of an exemplary system according to an embodiment herein to enable low cost and effective sale transactions between buyers and sellers. When a seller wishes to offer a good for sale or offer a service, the seller lists the good onto a server 104 using a client interface 101. For example, a seller may offer to sell a camera and a musician may offer a service of training people to play a musical instrument. The seller may decide to offer discounts to buyers of the good by listing PC along with the good. PC is also listed using the client interface 101 and the discount offered on a good is equal to the face value of the PC listed along with a particular good. For example, a seller may decide to offer a camera at 20% discount. The seller then lists a PC at a face value of $20 along with the camera priced at $100.

PCs can be bought by buyers and used further to buy goods online, offline, or alternatively, buyers may resell PCs to other buyers. Buyers can acquire PCs by paying for the PCs online or offline. The goods and PC listed by the seller are uploaded onto the server 104 using the client interface 101. The seller may choose to create one PC for one good or one PC for multiple goods. The seller may also choose to create multiple PC's for one good. Also, sellers may choose to list goods individually or group multiple goods and offer them for sale as a bundle. When a seller uploads goods and PC, an admin 102 verifies the authenticity of the seller and the goods. The admin 102 ensures that the seller is authorized to upload content onto the server 104 and also ensures that only goods that are allowed to be uploaded are being uploaded onto the server 104. When a buyer needs to buy a particular good, the buyer searches for the good using the client interface 101.

Buyers buy PEGs in order to purchase goods listed by sellers. A PEG can be used to secure a PC or the discount equal to the face value of said credit for a pre-determined period of time. Buyers can request for PEGs using the client interface 101. The request for a good or for PEGs is sent from the client interface 101 to the server 104. When a buyer requests for PEGs, the server 104 locates the required number of PEGs and allocates the PEGs to the requesting buyer. The buyer may choose to pay for the PEGs online or offline. The admin 102 controls the money transaction taking place between the buyer and the seller. After a buyer has obtained the required number of PEGs and the required good has been searched and found, the buyer may decide to “peg” the good. When a buyer “pegs” a good, the server 104 releases the PC listed along with the good to the buyer. The buyer thus acquires a PC from the particular seller. The face value of the PC is higher than the purchase price of the PEG and the validity of a PC lasts for a predetermined period of time. The buyer may acquire one PC using one PEG or multiple PCs using one peg or multiple PCs using multiple PEGS. After a buyer has acquired a PC from a seller, the buyer can purchase the “pegged” good before the expiry of the predetermined period of time and avail of the offered discount. The buyer may choose to pay for the good online or offline.

For example, if a buyer wishes to buy a camera, then the buyer searches for a camera using the client interface 101. On locating the camera, the buyer buys 1 PEG for $5 and “pegs” the camera using 1 PEG and acquires 1 PC from the seller. The seller may have offered a 20% discount on the camera worth $100 and listed 1 PC with the camera at a face value of $20. If the validity of the PC is 24 hours, then the buyer buys the camera after availing of the 20% discount before the expiry of 24 hours from the time of “pegging” the camera.

Buyers can also exchange PC with other buyers who have acquired PC. For example, if a buyer has acquired PC for a camera and later decides to buy a handycam, then the buyer can exchange the PC with another buyer who has acquired a PC for a handycam and now wants to buy a camera.

A memory 103 stores the details of sellers and the goods or PC listed by the sellers. The information of the buyers, the goods and PEGs bought by the buyers may also be stored in the memory 103. The information about the goods “pegged” by buyers and the validity period of the “pegged” goods may also be stored in the memory 103. The sever 104 may enable third party buyers to interface with the system and enable the third party buyers to buy or sell goods. A third party interface 105 enables the server 103 interface with third party buyers. In one embodiment, memory 103 may store data using relational database, object oriented database, or any other suitable data organization means.

### Method Flows

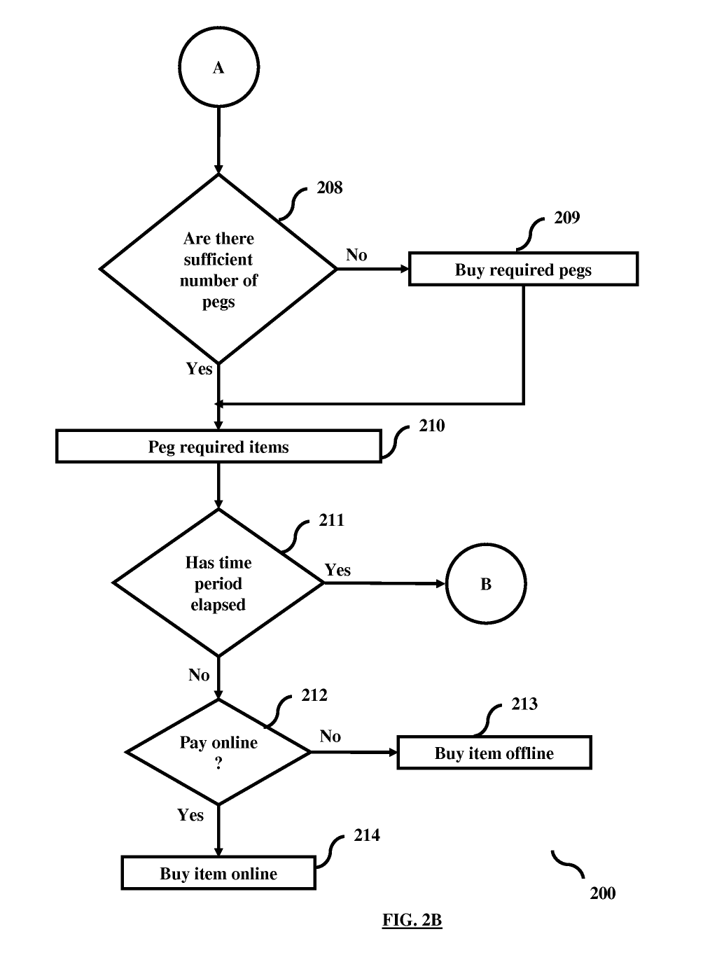

FIG. 2 is a flowchart depicting a method for enabling a buyer to search for and buy goods. When a buyer needs to buy a particular good or a service, the buyer searches for the good using a client interface. For example, the buyer may search for the good using a web interface, a T.V. interface, a mobile client interface, an interface based on SMS, or any other suitable interface. To be able to search for the good, the buyer logs in (201) to the server 104 using a client interface 101.

After logging in, in some embodiments, the buyer may decide to invite friends (202) to register on the server. If the buyer wants to invite friends, the buyer may send (203) an invitation to his friends. The buyer may choose not to invite any friends. The act of inviting friends may happen at any time during buyer's interaction with the system.

The buyer can buy (204) PEGs in order to purchase goods listed by sellers. The buyer can request for PEGs using the client interface. The client interface may be a TV interface, a web client interface, a mobile client interface, an interface based on SMS, or any other suitable interface. When a buyer requests for PEGs, the server 104 locates the required number of PEGs and allocates the PEGs to the requesting buyer. The buyer may choose to pay for the PEGs online or offline. The admin 102 maintains the details of PEGs bought by the buyer. The buyer searches (205) for the good using the client interface by entering the search string in the client interface. A buyer can search for a good by searching or browsing content on a website or by receiving a direct offer from the seller through email or SMS or by viewing an advertisement. If the server 104 locates the goods requested by the buyer, the buyer can view (206) the list. If the required good has been searched and found (207), and if the buyer has (208) the required number of PEGs, then the buyer may decide to “peg” (210) the good. If the buyer does not have the required number of PEGs, then the buyer may buy (209) the required number of PEGs. When a buyer “pegs” a good, the server 104 releases the PC listed along with the good to the buyer. The buyer thus acquires a PC from the seller that offered the good for sale. The face value of the PC is higher than the purchase price of the PEG and the validity of a PC lasts for a predetermined period of time. The buyer may acquire one PC using one PEG or multiple PCs using one peg or multiple PCs using multiple PEGS. After the buyer has acquired a PC from the seller, the buyer can purchase the “pegged” good before the expiry (211) of the validity of the PC acquired and avail of the offered discount. The buyer may choose to pay (212) for the good online or offline. If the buyer wants to buy (213) the good offline, then the server 104 generates a code towards the transaction made by the buyer and sends the code to the buyer. The buyer can then pay for the good at the sellers store using the code. If the buyer decides to buy (214) the good online then the buyer can pay for the good online. For example, the buyer may pay for the good by using a credit card. The various actions in method 200 may be performed in the order presented, in a different order or simultaneously. Further, in some embodiments, some actions listed in FIG. 2 may be omitted.

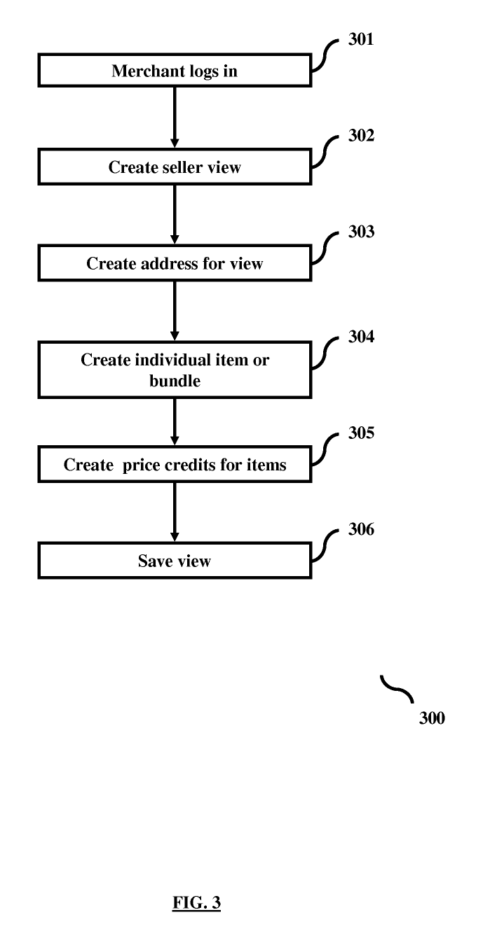

FIG. 3 is a flowchart depicting a method for enabling a seller to sell goods. When a seller wishes to offer a good for sale or offer a service, the seller lists the good onto a server 104 using the client interface. To be able to sell the good, the seller logs in (301) to the server 104. The seller then creates (302) a seller view on the client interface 101 and includes the details about the goods offered by the seller on the seller's view. For example, a seller may offer to sell a car, and the seller uploads details about the car on the view. The details may include price, color, year of manufacture, miles on the car if the car is a used car, and so on. The seller then creates (303) an address for the seller view. For example, when the client interface is a web interface, the seller may create an address for the seller page as http://pegpay.com/seller1. The seller may choose to list (304) goods individually or group multiple goods and offer them for sale as a bundle. The seller may decide to offer discounts to buyers of the good by creating PC (305) along with the good. The PCs are listed on the seller's view and the discount offered on a good is equal to the corresponding face value of a PC listed along with a particular good. After the seller has entered all required information, the seller saves (306) the view so that a buyer may be able to search for and view the details of the seller along with goods offered by the seller. The various actions in method 300 may be performed in the order presented, in a different order or simultaneously. Further, in some embodiments, some actions listed in FIG. 3 may be omitted.

In various embodiments, a commission fee may be delivered to a seller for each PEG that is used by a buyer to acquire a PC from the seller. In some embodiments, the commission may be delivered to the seller through wire transfer. However, various other mechanisms may be employed including sending a check, providing credits among others.

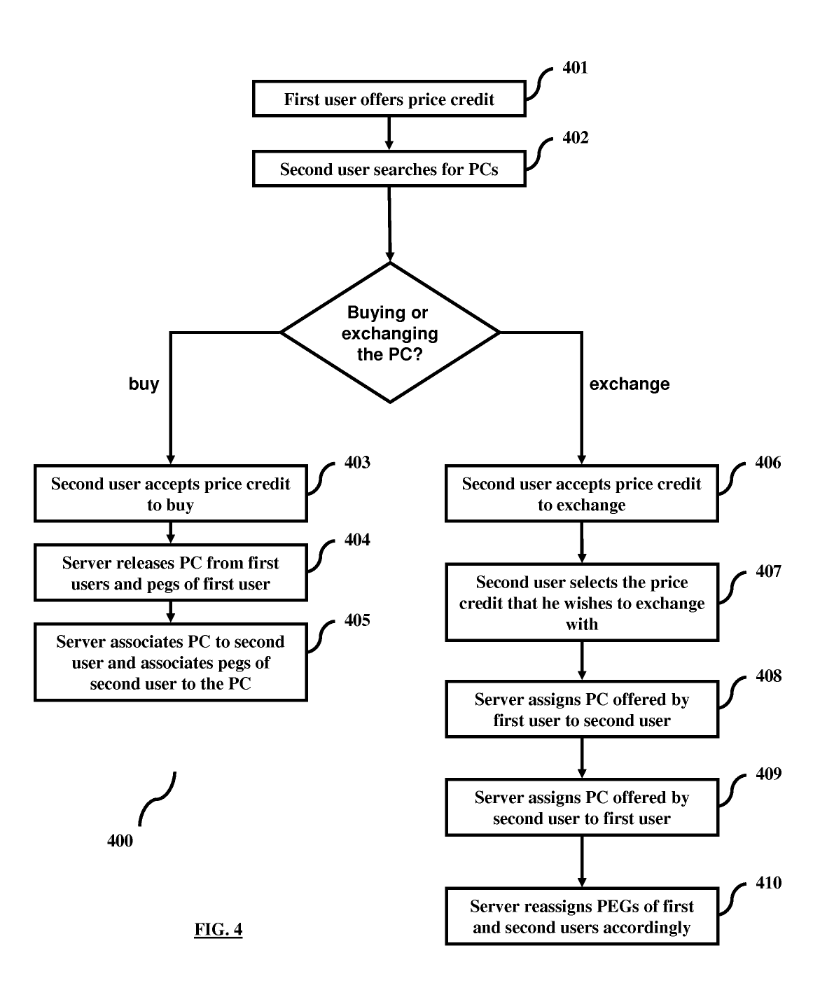

FIG. 4 is a flowchart depicting a method for enabling buyers to resell or exchange PCs. When a seller wishes to offer a good for sale or offer a service, the seller lists the good on the system 100 by uploading the details on to the server 104. The seller may decide to offer discounts to buyers of the good by listing one or more PCs along with the good. PCs are also listed on the system 100 and the discount offered on a good is equal to the face value of the PC listed along with a particular good. The seller may choose to create one PC for one good or one PC for multiple goods as a bundle. The seller may also choose to create multiple PCs for one good as well. When a buyer needs to buy a particular good, the buyer searches for the good. Buyers buy PEGs in order to purchase goods listed by sellers. When a buyer requests for PEGs, the server 104 locates the required number of PEGs and allocates the PEGs to the requesting buyer. After a buyer has obtained the required number of PEGs and the required good has been searched and found, the buyer may decide to “peg” the good. When a buyer “pegs” a good, the server 104 releases the PC listed along with the good to the buyer, and associates the PC to one or more PEGs from the buyer. The buyer thus acquires a PC from the particular seller in exchange for one or more PEGs. After a first buyer has acquired a PC for a good, the first buyer may decide to resell or exchange the PC for another good before the expiry of the validity period of the PC. The first buyer offers (401) a PC for resell or exchange on the system 100 using the client interface with relevant details. The relevant details may include the details of the PC that he is offering for resell or exchange, and the kind of PC or good that the first buyer is looking for in exchange, in case the first buyer is interested in an exchange of PCs. Other buyers that are also looking to buy or exchange PCs may search (402) for available PCs from buyers. If a second buyer needs the PC offered by the first buyer, then the second buyer may accept (403) the offered PC using the client interface.

If the PC offered by the first buyer is for resell and if the second buyer is willing to buy the PC on offer, the second buyer accepts the PC. The server 104 releases (404) the PC and the PEGs of first buyer used to acquire the PC to the first buyer. The server 104 then associates (405) the PC to the second buyer and also associates PEGs of the second buyer to the PC. The number of PEGs of second buyer associated with the PC resold is dependent on the offer. The number of PEGs could be equal to, higher or lower than the original number of PEGs used to peg the PC.

If the PC offered by the first buyer is for exchange and if the second buyer is willing to exchange a relevant PC according to the requirements of the exchange offer posted by the first buyer, the second buyer accepts (406) the PC on exchange offer. Further, the second buyer selects (407) the PC belonging to him to exchange with the PC offered by the first buyer. Once both PCs are identified, the server 104 releases the PC of first buyer from first buyer, and assigns (408) the PC to second buyer. Similarly, the server 104 releases the PC offered by second buyer from second buyer, and assigns (409) the PC to first buyer. The server 104 also reassigns (410) PEGs of first buyer to the second buyer, and those of second buyer to first buyer depending on the number of PEGs by each buyer for pegging the PCs offered for exchange. The first buyer may indicate the number of PEGs required to peg the PC offered by him when he creates the PC resell offer. The second buyer may select the number of PEGs required to peg the PC that he is willing to exchange at the time for accepting the PC from first buyer for exchange.

In various embodiments, buyers may resell or exchange their PCs for a profit or discount. The various actions in method 400 may be performed in the order presented, in a different order or simultaneously. Further, in some embodiments, some actions listed in FIG. 4 may be omitted.

### Web Interface Embodiment

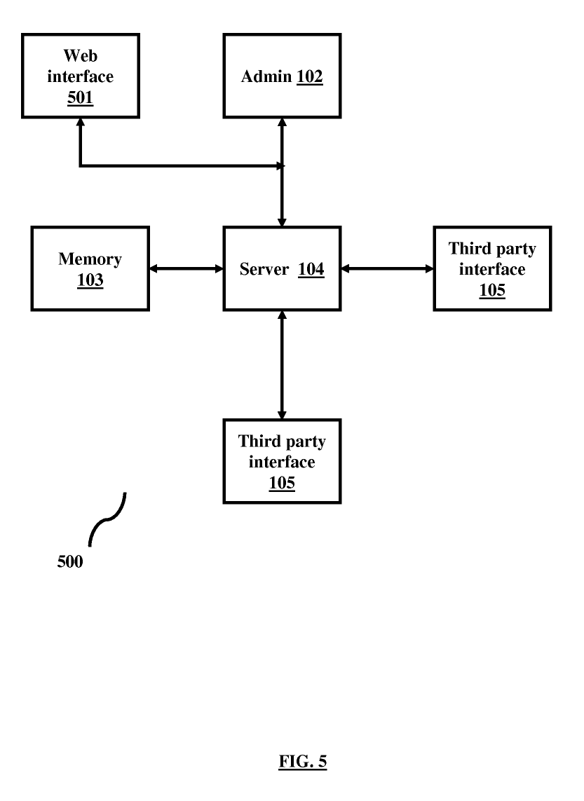

In one embodiment, the client interface shown in FIG. 1 is a web interface. FIG. 5 illustrates a block diagram of a network wherein a web interface (501) enables sale transactions between buyers and sellers. Sellers, buyers, and third party users may use the web interface for one or more of their interactions with the system. In various embodiments, web interface may be accessible to users through a web browser like the Internet Explorer or Mozilla Firefox. In other embodiments, web interface may also be accessible through a custom application that connects to the server 104.

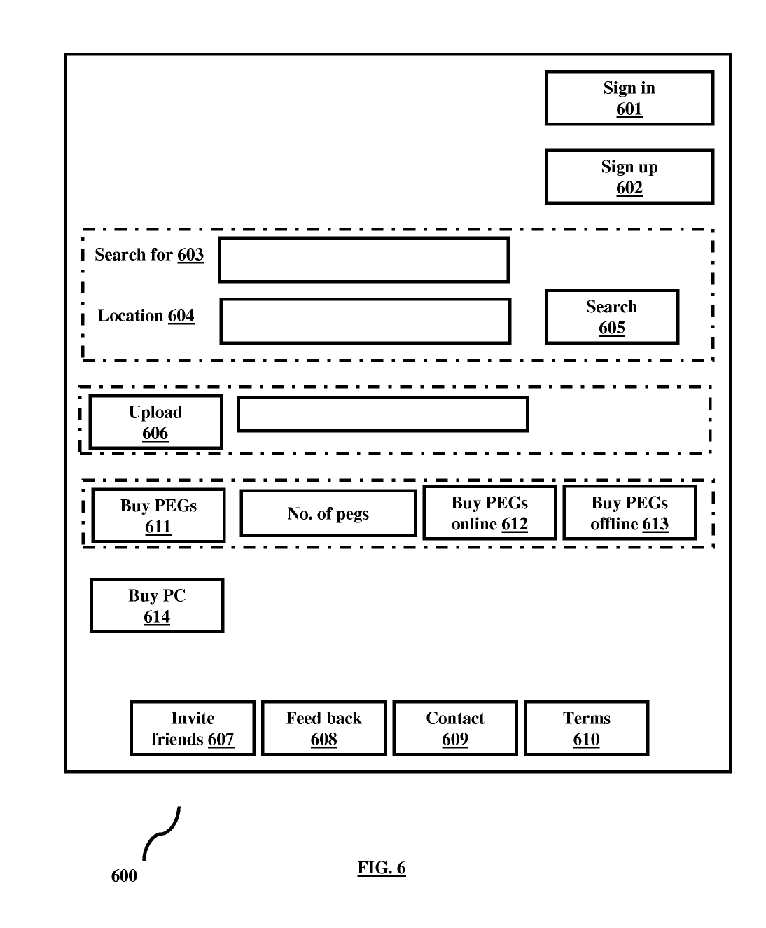

FIG. 6 illustrates a schematic diagram of a web page, according to an embodiment herein. The web page has tabs for registering, logging in, searching, uploading, buying PEGs, invite friends, sending a feed back, contacting the web service provider, and terms and conditions for registering. The page can be accessed and viewed using T.V., web browser, a mobile interface through a WAP phone, or any other suitable means.

A user may register to become an active member of the web site and the user can register by clicking on sign up 602 tab and entering details about the user. For example, the details entered by the user may be the user's name, e-mail id, phone number and address of the user. After registering the user can log in at a later point in time by clicking on a sign in 601 tab to sell or buy goods or PEGs. If the user wants to invite friends, the user can send an invitation to the user's friends after including a link to the web site in the invitation. The user (both buyers and sellers) can invite friends by clicking on an invite friends 607 tab. Upon clicking the invite friends 607 tab, the user may be presented options to fill email ids of friends that the user would like to invite.

If the user is a seller and wants to sell goods, the seller may list the goods that he is willing to offer. The seller can list goods or PCs using the upload 606 tab. Upon selecting to upload, the seller may be presented with more options to fill the details of the good that the seller is uploading, and to upload data relating to the PCs and any other marketing collateral.

If the user is a buyer and wants to buy any good, the buyer may buy PEGs in order to purchase goods listed by sellers. The buyer can buy PEGs by clicking on the buy PEGs 611 tab. The buyer buys the required number of PEGs by entering the required number of PEGs. The buyer may choose to pay for the PEGs online or offline. If the buyer decides to pay for the PEGs online, then the buyer clicks on buy PEGs online 612 tab and if the buyer wants to buy PEGs offline then the buyer clicks on buy PEGs offline 613 tab. Upon choosing to buy PEGs offline, the system may generate a unique id, which is used for identifying the transaction, using which the buyer could pay for PEGs offline.

If the buyer wants to buy a good, then the buyer searches for the good using the client interface by entering the search string in the search for field 603. The buyer can enter the preferred location to buy the good by entering the location information in the location 604 field. For example, if the buyer wants to buy a cell phone from New York, then the buyer enters “cell phone” in search for 603 field and “New York” in location 604 field. After entering the search string and the location information, the buyer can click on search 605 tab to retrieve information about the good from the server 104. If the buyer wants to buy PC's directly, then the buyer can click on buy PC 614 tab to buy the PC's. A buyer may use this feature if he already knows the details of a PC and is revisiting to buy the PC. In various embodiments, a single buyer can act as both seller and buyer on the system.

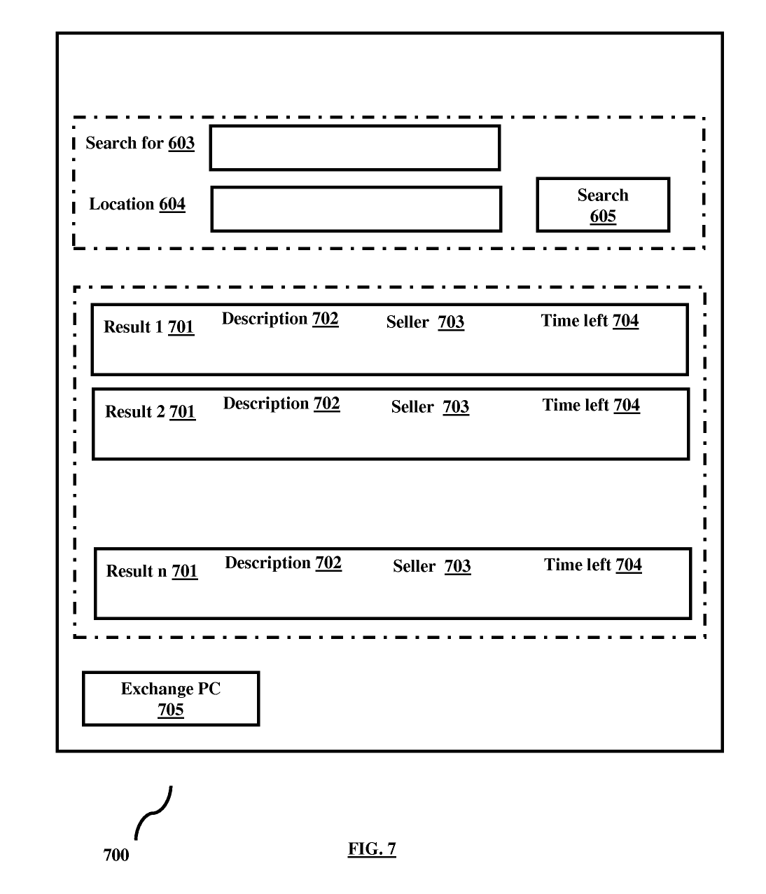

FIG. 7 illustrates a schematic diagram of a web page, according to an embodiment herein. After registering, the buyer can log in at a later point in time by clicking on a sign in 601 tab, to sell or buy goods or PEGs.

If the buyer wants to buy a good or avail of any service, then the buyer searches for the good using the client interface by entering the search string in the search for 603 field. After entering the search string and the location information, the buyer can click on search 605 tab to retrieve information about the good from the server 104. The retrieved information from the server 104 is displayed to the buyer as a list of results. The list of results indicates the search result 701, a description of the result in a description 702 field, the seller selling the good in a seller 703 field, and the time left for the expiry of the discount offered on the good as indicated by the time left 704 field. If the buyer has found the required good, then the buyer can click on the appropriate result 701 tab to be able to view the details of the good, and buy the required good.

If a buyer has already acquired a PC for a good, the buyer may decide to exchange the PC for another good before the expiry of the validity period of the PC. To exchange the PC with a second buyer, the buyer clicks on exchange PC 705 tab. Upon choosing to exchange, the buyer may be presented with details of PCs on offer for exchange from other buyers using the system. If the buyer likes a particular offer, then the buyer may choose to exchange PCs.

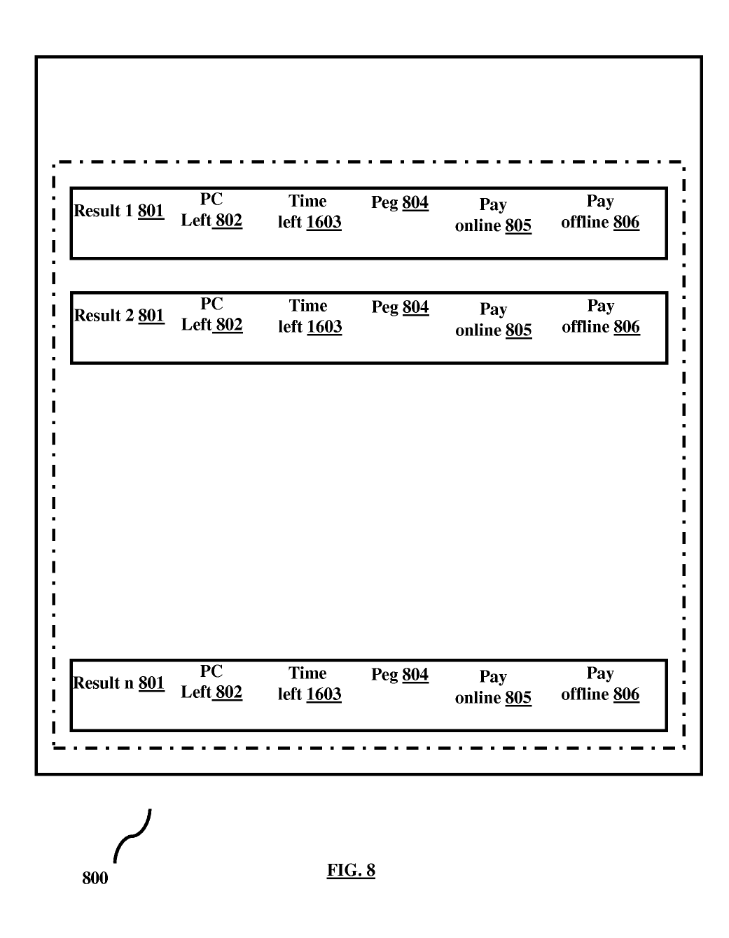

FIG. 8 illustrates a schematic diagram of a web page, according to an embodiment herein. If the buyer wants to buy a good or avail of any service, then the buyer searches for the good using the client interface by entering the search string in the search for 603 field. The information requested by the buyer is retrieved from the server 104 and displayed to the buyer as a list of results. If the buyer has found the required good, then the buyer can click on the appropriate result 701 tab to be able to buy the required good. After clicking on result 701 tab the uses can view the page wherein the buyer can “peg” and buy the required good. The page lists the results along with details about each result. The details may include information about the PCs remaining for the particular good mentioned under PC left 801 field, the time left for the expiry of the validity period of the PC is indicated under a time left 803 field. If more than one PC exists for a good or a service, the multiple results may be listed for the same good.

If the buyer wants to “peg” a particular result, then the buyer can “peg” the result using the “Peg” 804 tab. When a buyer “pegs” a good, the server 104 releases the PC listed along with the good to the buyer. The buyer thus acquires a PC from the particular seller. The buyer may acquire one PC using one PEG or multiple PC using one peg or multiple PC using multiple PEGS. After a buyer has acquired a PC from the seller, the buyer can purchase the “pegged” good before the expiry of the predetermined period of time and avail of the offered discount. The buyer may view the lists of PCs pegged at any time along with the time remaining for expiry for each of the PCs.

The buyer may choose to pay for the good online or offline. If the buyer decides to pay for the good online, then the buyer clicks on pay online 805 tab and if the buyer wants to pay for the good offline then the buyer clicks on pay offline 806 tab. The buyer can choose to pay for each good individually or first select all the required goods and pay for all goods at once. In an embodiment the tabs may be placed at the top of the page, however, the tabs may also be placed at other locations in the page. Also, tabs may be added in the page if required.

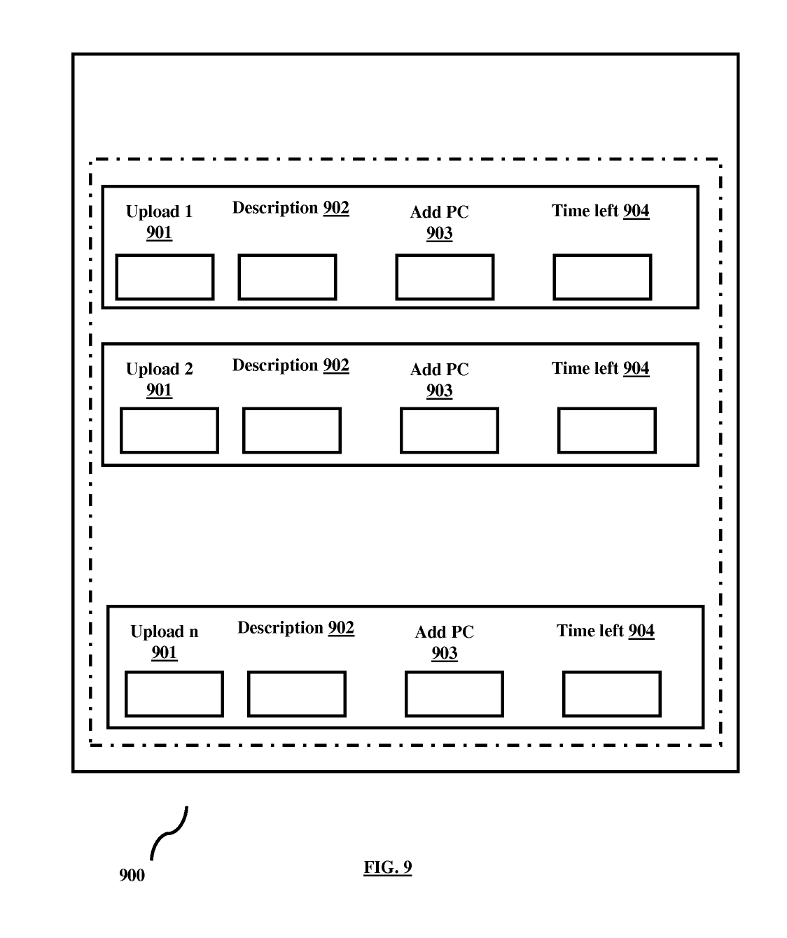

FIG. 9 illustrates a schematic diagram of a page used by sellers to lists goods and PCs. A seller first registers to become an active member of the web site and the seller can register by clicking on sign up 602 tab and entering details about the seller. After registering the seller can log in at a later point in time by clicking on a sign in 601 tab to sell goods.

If a seller wants to sell goods, the seller lists the goods on the system. The seller can list goods using the upload 606 tab. The seller then creates a seller page and includes the details about the goods in the page. The details may include description about the good name entered in a description 902 field. The seller then creates an address for the seller page. The seller may choose to list goods individually or group multiple goods and offer them for sale as a bundle. The seller may decide to offer discounts to buyers of the good by creating PC along with the good. The PCs are listed along with the corresponding goods. The discount offered on a good is equal to the face value of the PC listed along with a particular good. The PC can be listed along with a particular good using the add PC 903 field. The seller can assign a validity period to each PC by indicating the validity period in a time left 904 field. The seller then uploads the information onto the server 104 by clicking on an upload 901 tab. After the seller has entered all required information, the seller saves the page so that a buyer may be able to view the page.

### TV Interface Embodiment

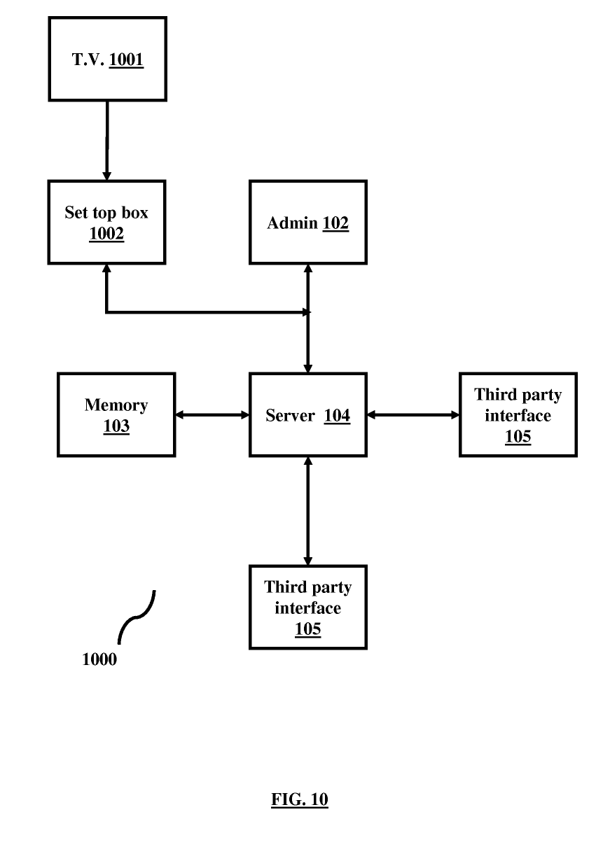

In another embodiment, the client interface shown in FIG. 10 is a TV interface that comprises of a T.V. and a set top box. FIG. 10 illustrates a block diagram of a network wherein a T.V. 1001 enables sale transactions between buyers and sellers, according to an embodiment herein. Sellers, buyers and third party users may use a T.V. interface for one or more their interactions with the system. In one embodiment, buyers, sellers and third party users may be able to view web pages while watching TV on the TV screen. Buyers, sellers, and third party users may browse web pages on TV using their TV remote. Such interaction with web pages while watching TV may be enabled by a set top box 1006.

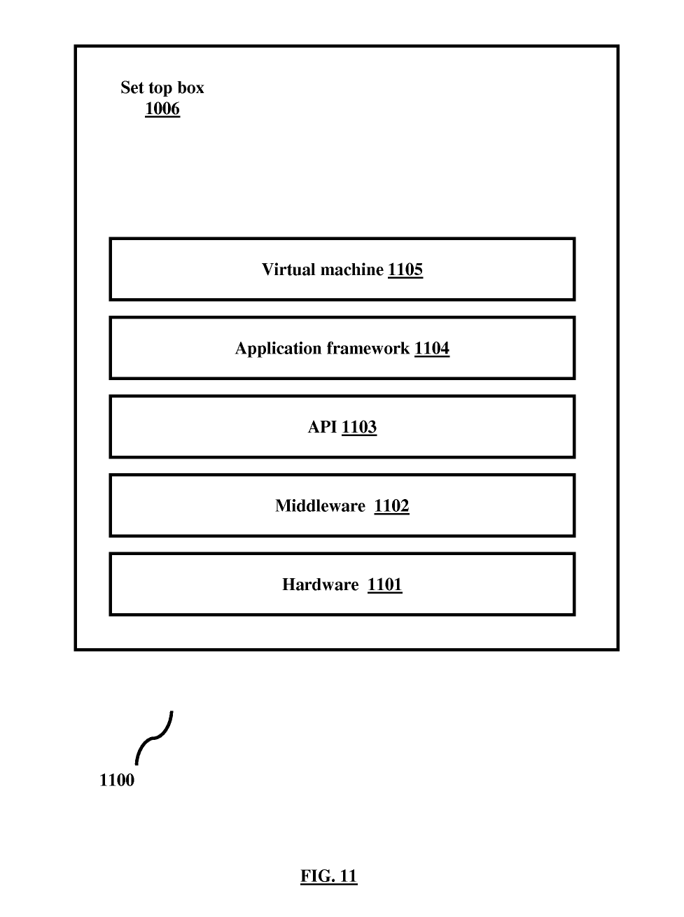

FIG. 11 illustrates a block diagram of a set top box, according to an embodiment herein. This example embodiment is based on Verizon's FiOS TV architecture (https://www22.verizon.com/fiosdeveloper/General/FiosDevCenterExt.aspx). The set top box 1006 has different layers helping users search for and upload goods onto the server 104. A hardware 1101 layer helps the user interact with hardware components in the set top box 1006 supporting different kinds of functionalities. For example, a set top box 1006 may support high definition television and T.V.R. A middleware 1101 has the operating system helping in running the different hardware components of the set top box 1006. For example, the operating system may direct a processor in the set top box to send data from the set top box 1006 to the server 104. An API 1103 layer is an extraction layer that exposes the capabilities of the set top box 106 to the user. For example, the API 1103 layer helps a user search for a good whose information has been uploaded onto the server 104. An application framework 1104 layer has interfaces needed by the user to build applications that can be uploaded onto the server 104. The application framework 1104 layer comprises graphics interface, events interface, timer interface and web-service interface. The graphics interface helps the user interact with the graphics in any content downloaded from the server 104. The events interface helps the user in communicating with the set top box 1006 framework and handling the remote key buttons. The timer interface helps the user receive notifications about any scheduled events. For example, a user may be notified about the expiry of the validity period of a PC. A web-service interface takes requests for a webpage, obtains the webpage from the server 104 and displays the webpage to the user. A virtual machine 1105 layer has the framework in which the application is written in the set top box 1006. For example, the applications may be written using LUA virtual machine. When a webpage is obtained from the server 104 and displayed to the user, the virtual machine 1105 manages the life cycle of the displayed content.

In yet another embodiment, the client interface shown in FIG. 1 is an SMS interface. Sellers, buyers, and third party users may use an SMS interface for one or more interactions with the system. For example, a buyer may use a short code to search and may use a command such as SRC XXXXX, where XXXXX may be the numerical code for a good. When a seller wishes to offer a good for sale or offer a service, the seller may list the good on the system by sending an SMS. For example, a seller may offer to sell a camera by sending a short code as an SMS to the server 104 and the short code may be SELL 56567. The message may be sent from a mobile communication device capable of sending SMS messages to the server 104 through an SMS gateway.

### Low Cost and Effective Financing

In some embodiments, sellers may offer merchant tokens with varying face values. A merchant token is a virtual currency offered by a seller that can be used an alternative mode of payment in addition to payment modes like cash, credit, or debit. Therefore, a seller may list his virtual currency of varying face values in the form of merchant tokens. These merchant tokens may be offered to buyers at a discount on the face value. The discount value could be equal to a PC that a buyer already bought. Or, the discount could be a fixed discount percentage on the face value of a merchant token.

The merchant tokens may have an activation date (the date from which the merchant token is valid) that is after the date of purchase of the corresponding one or more PCs. The merchant may also have a validity date (the date till which the merchant token can be redeemed).

In one embodiment, buyers that have PCs may buy merchant tokens using PCs they possess. Buyers may use the PCs that they have as the discount value on the face value of a merchant token. For example, let a buyer have a PC with face value of USD 25 relating to a good with a list price of USD 100, which means the buyer has a price credit that offers him USD 25 as discount. Now, the buyer could use the PC with face value of USD 25 as discount to buy merchant tokens worth USD 100. In this case, the buyer would pay USD 75 as he is using the PC with face value of USD 25 as the discount. While PCs are related to particular goods, merchant tokens may not be related to any specific good. Merchant tokens may be used to buy any good.

In different embodiments, merchant tokens may be offered online (digitally) or offline (physical token). And, in some embodiments, buyers may be able to buy merchant tokens directly without having to buy PCs.

In some embodiments, a buyer may sell merchant tokens that he has bought at a discount different (or same) from the discount at which he bought the merchant tokens. This allows for buyers to make profit from reselling merchant tokens that may not use. However, the buyer may sell merchant tokens only after the merchant tokens are activated (that is, after the activation date), and only before the expiry of the validity period (or before the expiry date) of the merchant tokens. In some embodiments, buyers may be able to sell merchant tokens even before the date of activation.

Sellers may use merchant tokens as a means to raise finance without having to go through the more traditional and formal financing routes like venture financing or debt financing. Sellers may pre-sell merchant tokens, even before launch of any goods, at a discount and set an activation date at a later date for such merchant tokens. Sellers could use the money received from the sale of merchant tokens for developing their business. Buyers that buy merchant tokens also obtain an incentive as they get to buy goods offered by the seller at a discount, which may not be normally available.

Selling and buying of merchant tokens may be enabled by the system using one or more of client interfaces like web interface, and TV interface as disclosed herein.

The embodiments disclosed herein can be implemented through at least one software program running on at least one hardware device and performing network management functions to control the network elements. The network elements shown in FIG. 1, FIG. 6, FIG. 11 and FIG. 12 include blocks which can be at least one of a hardware device, or a combination of hardware and software modules.

The embodiment disclosed herein specifies a system for enabling sale transactions between sellers and buyers. The mechanism allows sellers to offer discounts on goods and allows buyers to avail of the discount providing a system thereof. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

1. Method of enabling sale transactions between buyers and sellers, said method enabled by a system comprising one or more client interfaces, and a server, said method comprising:
providing virtual currency PEGs as an incentive for buyers to purchase goods;
providing at least one client interface for buyers to:
buy one or more PEGs,
search for available PC from one or more sellers, using one or more PEGs to acquire one or more PC available, and using said one or more PC to buy goods with discount, where discount on a good is equal to the face value of price credit (PC) being used to buy said good;
providing at least one client interface to enable sellers to:
list one or more PCs, list one or more goods for buyers to purchase using one or more said PCs, and accept said one or more PCs to offer discount on one or more goods purchased by a buyer, where discount on a good is equal to face value of PC being used to purchase said good;
deliver a commission fee to a seller for each PEG that is used by a buyer to acquire a PC from said seller; and
providing a server to accept requests from buyers and sellers, and to enable sale transactions.

2. The method as in claim 1, where price of a PEG is less than face value of a PC.

3. The method as in claim 1, where said client interface is one of TV interface, web client interface, mobile client interface, and SMS interface.

4. The method as in claim 1, where there is no additional processing fee for buying goods when said goods are bought using said at least one client interface.

5. The method as in claim 1, said method further comprising enabling exchange of PCs between users, wherein exchange of PCs further comprises:
a first buyer offering a PC for exchange using a client interface;
a second buyer accepting offer from said first buyer using a client interface;
said server releasing a PEG from said first buyer; and
said server associating said PC to a PEG of said second buyer.

6. A method of buyer purchasing goods, said method enabled by a system comprising of a client interface, and a server, said method comprising:
said buyer requesting to buy one or more PEGs using a client interface;
said server allocating said one or more PEGs to said buyer upon receipt of payment;
said buyer searching for PC from one or more sellers using said client interface;
said buyer requesting to acquire one or more PC of his or her choosing using one or more of said PEGs using said client interface; and
said server allocating said one or more PC to the buyer in exchange for one or more said one or more PEGs, wherein each of said one or more PC has a predetermined validity period.

7. The method as in claim 6, where said client interface is one of TV interface, web client interface, mobile client interface, and SMS interface.

8. The method as in claim 6, wherein said method further comprises of:
said buyer purchasing one or more goods using said one or more PC before the expiry of validity of said one or more PC using said client interface, wherein discount is applied to price of good bought where said discount is equal to the face value of PC used to buy said good.

9. The method as in claim 6, where there is no additional processing fee for purchasing goods.

10. The method as in claim 6, wherein said method further comprises of:
said buyer purchasing one or more goods using one or more said PC before the expiry of validity of one or more said PC at a seller's store, wherein discount is applied to purchase price of good being purchased, where said discount is equal to the face value of PC used to purchase said good.

11. A method of seller selling goods, said method enabled by a system comprising of a client interface, and a server, said method comprising:
a seller requesting, using said client interface, said server to list one or more PC on said server;
said server listing said one or more PC;
said seller requesting, using said client interface, to list one or more goods on said server for buyers to purchase at discount using one or more said PC; and
said server listing one or more said goods.

12. The method as in claim 11, where said client interface is one of TV interface, web client interface, mobile client interface, and mobile client interface.

13. The method as in claim 11, wherein said method further comprises of:
said server accepting one or more PC from a buyer as discount to one or more goods purchased by said buyer, where discount offered for a PC is equal to the face value of said PC.

14. The method as in claim 11, where there is no additional processing fee for buying goods.

15. The method as in claim 11, wherein said method further comprises of:
said seller accepting one or more PC from a buyer as discount to one or more goods purchased by said buyer, where discount offered for a PC is equal to the face value of said PC.
